(19) United States
(12) Patent Application Publication
(10) Pub. No.: US 2012/0119676 A1
(43) Pub. Date: May 17, 2012

(54) FLYBACK POWER CONVERTER WITH DIVIDED ENERGY TRANSFER ELEMENT

(75) Inventor: Jianming Yao, San Jose, CA (US)

(73) Assignee: POWER INTEGRATIONS, INC., San Jose, CA (US)

(21) Appl. No.: 12/946,497

(22) Filed: Nov. 15, 2010

(51) Int. Cl. H05B 41/36; H02M 3/335; H01F 27/28

(52) U.S. Cl. 315/297; 336/170; 363/21.12

(57) ABSTRACT

A divided structure energy transfer assembly for use in a flyback power converter is disclosed. An example energy transfer includes first and second magnetic cores. First and second input windings are wound around the first and second magnetic cores, respectively. The first input winding is coupled in parallel with the second input winding. First and second output windings are wound around the first and second magnetic cores, respectively. A rectified output of the first output winding is coupled in series with a rectified output of the second output winding. The first and second input windings have a first polarity and the first and second output windings have a second polarity. The first polarity is an opposite of the second polarity.

### BACKGROUND INFORMATION

1. Field of the Disclosure

The present invention relates generally to energy transfer. More specifically, the present invention relates to a divided energy transfer element for use in a flyback power converter.

2. Background

A wide variety of ac-dc and dc-dc power supplies are used in a variety of applications ranging for example from industrial equipment to household appliances. Flyback power converters are often an attractive design choice because of their desired features as well as the isolation that they provide. A known flyback power converter operates by storing energy in a magnetic field of an energy transfer element when a power switch is switched on and transmitting the energy to an output load when the power switch is switched off. An energy transfer element, such as a mutual inductor or coupled inductors, in an isolated flyback power converter behaves similar to a transformer with the input and output windings having opposite polarities. It is appreciated that energy transfer elements are often illustrated in electrical schematic diagrams with opposite dot positions and are often also referred to as flyback transformers.

In the recent years, the utilization of light emitting diodes (LEDs) has become very popular in a variety of applications including for example providing backlighting for large flat screen monitors and television screens. The brightness of an LED as well as the color of light that is emitted from an LED are sensitive to the current through the LED. As a result of these characteristics, as well as the LED's behavior as a forward biased diode, tight current controls are often necessary when driving LEDs. Accordingly, ac-dc off-line flyback converters with tight current controls have often been used to drive LEDs that are used to provide backlighting for large flat screen monitors and television screens. However, due to the high output voltage and high power requirements, long strings of LEDs are separated into shorter multiple strings of LEDs. Each of the shorter multiple strings of LEDs are then individually powered with separate current controllers.

The use of multiple strings of LEDs with separate current controllers to drive each string creates a number of complexities. For instance, there is the added complexity of providing balanced current distribution for all the individual strings of LEDs. Unbalanced currents can result in undesired uneven output brightness and color from the multiple strings of LEDs. In addition, by having multiple separate current controllers to drive each of the separate multiple strings of LEDs, additional components are required, which drives up the costs to power the multiple strings of LEDs.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 shows generally a schematic of an example flyback power converter including an energy transfer element having multiple magnetic cores and windings in accordance with the teachings of the present invention.

FIG. 2 shows generally a schematic of another example of a flyback power converter including an energy transfer element having multiple magnetic cores and windings in accordance with the teachings of the present invention.

FIG. 3 shows generally a schematic of an example energy transfer element having multiple magnetic cores and windings in accordance with the teachings of the present invention.

FIG. 4A shows generally a cross section of a portion of an example energy transfer element including windings wound around a magnetic core in accordance with the teachings of the present invention.

FIG. 4B shows generally a cross section of a portion of another example energy transfer element including windings wound around a magnetic core in accordance with the teachings of the present invention.

### DETAILED DESCRIPTION

Methods and apparatuses for implementing a flyback power converter with an energy transfer element having a divided structure are described. In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

As will be discussed, a flyback power converter including a divided energy transfer element that may be utilized in a flyback power converter to provide high power and high output voltage with a low profile is disclosed. Examples of the disclosed flyback power converter with a divided energy transfer element may be utilized to drive long single strings of light emitting diodes (LEDs), such as those that are utilized to provide backlighting for large flat screen monitors and television screens. Examples of the disclosed flyback power converter design enjoy a low profile structure while providing high power and high output voltage with reduced loss, higher efficiency and lower heat dissipation. In addition, examples of the disclosed flyback power converter design provide a single current control for a long single string of LEDs, which therefore provides homogeneous output brightness and color for all of the LEDs in the long single string of LEDs.

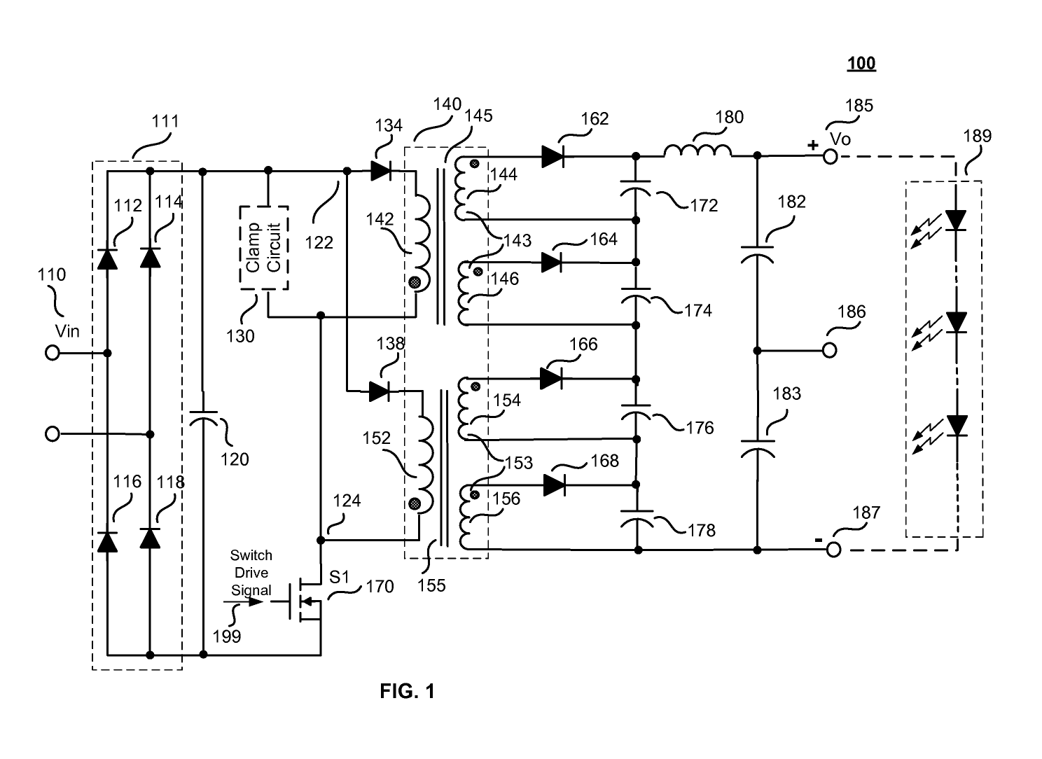

To illustrate, FIG. 1 shows a schematic of one example of a flyback power converter including a divided energy transfer element having multiple magnetic cores and windings in accordance with the teachings of the present invention. As shown in the depicted example, a flyback power converter 100 includes a rectifier 111 having diodes 112, 114, 116 and 118 coupled to rectify an ac signal Vin received at an input 110 of the flyback power converter 100. A rectified dc signal is generated by rectifier 111 and is filtered by a capacitor 120, which is coupled across the output of rectifier 111 as shown. A divided energy transfer element 140 having a plurality of magnetic cores, including first magnetic core 145 and second magnetic core 155, is also included in flyback power converter 100 as shown.

In one example, divided energy transfer element 140 includes a plurality of input windings, including a first input winding 142 wound around first magnetic core 145 and a second input winding 152 wound around second magnetic core 155. It is noted that input windings 142 and 152 may also be referred to as primary windings. As shown in the example, first input winding 142 is coupled in parallel with second input winding 152. In one example, a clamp circuit 130 is also coupled across first input winding 142 and second input winding 152 as shown. In the example depicted in FIG. 1, a first input diode 134 is coupled between node 122 and first input winding 142, and a second input diode 138 is coupled between node 122 and second input winding 152 as shown.

In one example, a power switch S1 170 is also coupled to first and second inputs windings 142 and 152 at node 124, and to the input 110 of flyback power converter 100. In one example, a switch drive signal 199 is coupled to be received by power switch S1 170 to control the switching of power switch S1 170. In one example, capacitor 120 provides a low impedance path for bypassing the switching current ripples. In one example, a clamp circuit 130 is coupled across the first and second input windings 142 and 152 to protect the power switch S1 170 from the high amplitude oscillations due to the leakage that can occur when power switch S1 170 is turned off. Depending on design requirements, clamp circuit 130 may include a known resistor-capacitor-diode arrangement, a known zener-diode arrangement, or any other suitable type of clamp circuitry in accordance with the teachings of the present invention.

As shown in the depicted example, divided energy transfer element 140 also includes a plurality of output windings, including a first output winding 143 wound around first magnetic core 145 and a second output winding 153 wound around second magnetic core 155. It is noted that output windings 143 and 153 may also be referred to as secondary windings. As shown in the example, a rectified output of first output winding 143 is coupled in series with a rectified output of second output winding 153. In one example, first output winding 143 includes a plurality of sections having rectified outputs coupled in series, including first section 144 and second section 146 as shown. Similarly, second output winding 153 includes a plurality of sections having rectified outputs coupled in series, including first section 154 and second section 156 as shown. As shown in FIG. 1, output windings 143 and 153 are wound around magnetic cores 145 and 155 to have a polarity that is opposite to the polarity of input windings 142 and 152. As can be appreciated, the opposite polarities of the input windings 142 and 152 and the output windings 143 and 153 are illustrated in FIG. 1 with the dot polarities shown on opposites ends of the respective windings as indicated.

In the example shown in FIG. 1, rectifying output diodes and filter capacitors are coupled to each of the plurality of sections of the plurality of output windings of energy transfer element 140. To illustrate, output diode 162 is coupled to first section 144 of output winding 143, output diode 164 is coupled to second section 146 of output winding 143, output diode 166 is coupled to first section 154 of output winding 153, and output diode 168 is coupled to second section 156 of output winding 153 as shown. Similarly, filter capacitor 172 is coupled across first section 144 of output winding 143, filter capacitor 174 is coupled across second section 146 of output winding 143, filter capacitor 176 is coupled across first section 154 of output winding 153, and filter capacitor 178 is coupled across second section 156 of output winding 153 as shown.

Continuing with the illustrated example, an inductor 180 is coupled between the output windings 143 and 153 of energy transfer element 140 and an output 185 of flyback power converter 100. In addition, capacitors 182 and 183 are stacked and coupled across output windings 143 and 153 at the output 185 as shown. As shown in the illustrated example, the node between stacked capacitors 182 and 183 at the output 185 is labeled as node 186. As shown, a load 189 is to be coupled to the output 185 of flyback power converter 100. In one example, load 189 is a long single string of LEDs to be powered by flyback power converter 100 in accordance with the teachings of the present invention.

In operation, when the power switch S1 170 is switched on in response to switch drive signal 199, current flows through power switch S1 170, input diodes 134 and 138 and input windings 142 and 152 in parallel. However, because of the opposite polarities corresponding to the winding directions of output windings 144, 146, 154 and 156 (note the opposite dot sign of input and output windings) and the reverse directions of the output diodes 162, 164, 166 and 168, energy is not transferred to the output windings 143 and 153 and to the load 189 while power switch S1 170 is switched on. Instead, energy is stored in the air gap of magnetic cores 145 and 155 while power switch S1 170 is switched on.

However, when power switch S1 170 is switched off in response to switch drive signal 199, the direction of current at output windings 143 and 153 reverses, and the energy that was stored in the air gaps of each magnetic core 145 and 155 while power switch S1 170 was previously switched on, is then transferred through the output windings 143 and 153 to the load 189 at the output 185 of the flyback power converter 100. The current through each output winding is rectified by the output diodes 162, 164, 166 and 168. In the illustrated example, ripple currents are filtered by the output bulk capacitors 172, 174, 176 and 178. By series coupling of the output bulk capacitors 172, 174, 178 and 178 as shown and thereby stacking the output voltages across all of the output windings 143 and 153, the total required high voltage output across load 189 is achieved in accordance with the teachings of the present invention. In the example, inductive filter 180 and the bulk electrolytic capacitors 182, 183 further smooth the dc output across the load 189, which in one example is the long single string of LEDs.

Thus, it is appreciated that the example illustrated energy transfer element 140 of the flyback power converter 100 is divided into a plurality of transformers. In the illustrated example, each divided transformer has two sections of rectified outputs of output windings on the same magnetic core that are coupled in series with each other as well as in series with the two sections of rectified outputs of the other output windings of the second transformer. As a result, the output voltages are added together. The combined output voltages of the four output winding sections result in a very high total output voltage across the output 185 of flyback power converter 100. Since the high output voltage is distributed across the multiple windings and multiple stacked capacitors, a cost effective design is achieved since smaller lower profile components may be utilized because of the lower voltage requirements. Furthermore, a cost effective design is achieved with a low profile transformer with reasonable number of layers and safe isolation of each winding plus the lower rating of each output electrolytic capacitor. The series coupling of capacitors 182, 183 as the final output capacitive filter stage also provides a cost effective lower voltage rating of electrolytic capacitors as well as access to a fraction of total output voltage at node 186 in accordance with the teachings of the present invention.

Indeed, when comparing example flyback power converters 100 with divided energy transfer elements 140 as shown in FIG. 1 with known conventional isolated flyback power converter designs, the known isolated flyback power converters, if designed for high output voltage and high power rating, require large bulky transformers with large dimension cores having multiple layers of heavy wires. By having multiple layers of heavy wires, the known isolated flyback power converters suffer from the parasitic capacitance between the large numbers of layers. This higher value of parasitic capacitance could create lower frequency resonance that may affect operation and in some case could make operation impossible. As well, the large numbers of layers make a low impedance path for the very high frequency common mode (CM) noise that is created by the sharp edges of the high frequency switching pulses in the known isolated flyback power converters. This unwanted capacitive coupling therefore contributes to the transfer of the CM noise, which then becomes a main source of electro magnetic interference (EMI) causing failure in electro magnetic compliance (EMC) regulatory tests. Furthermore, the height and volume of the transformer core and windings in known flyback power converters makes the size of known flyback power converter unattractive for use in high power high output voltage applications, such as for example flat screen monitors television screens.

Examples of flyback power converters in accordance with the teachings of the present invention utilize a low profile divided energy transfer element structure that provide high output voltage, such as for example in the range of 500 volts, and high power, such as for example in the range of 60 watts. Such high voltage high power applications may include driving loads of long single strings of LEDs in applications such as large flat screen monitors and television screens.

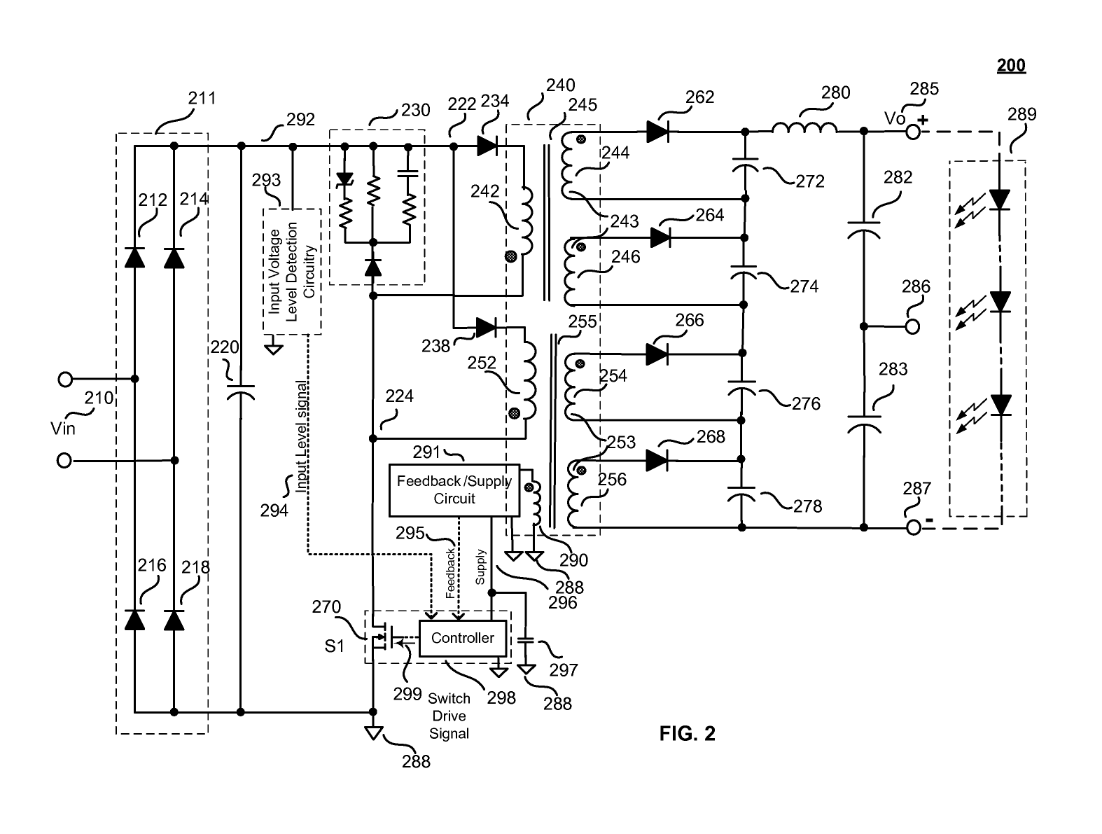

FIG. 2 shows generally a schematic of another example flyback power converter including an energy transfer element having multiple magnetic cores and windings in accordance with the teachings of the present invention. As shown, FIG. 2 shows similar flyback power converter circuitry and components with divided structure of the energy transfer element as illustrated in the FIG. 1 with additional detail of example input side control circuitry coupled to the power switch S1 270.

To illustrate, the example of FIG. 2 shows a flyback power converter 200 including a rectifier 211 having diodes 212, 214, 216 and 218 coupled to rectify an ac signal Vin received at an input 210 of the flyback power converter 200. A rectified dc signal is generated by rectifier 211 and is filtered by capacitor 220 coupled across the outputs of rectifier 211 as shown. A divided energy transfer element 240 having a plurality of magnetic cores, including first magnetic core 245 and second magnetic core 255, is also included in flyback power converter 200 as shown. In one example, divided energy transfer element 240 has a plurality of input windings, including a first input winding 242 wound around first magnetic core 245 and a second input winding 252 wound around second magnetic core 255. As shown in the example, first input winding 242 is coupled in parallel with second input winding 252. In one example, a clamp circuit 230 is also coupled across first input winding 242 and second input winding 252 as shown.

In the example depicted in FIG. 2, a first input diode 234 is coupled between a node 222 and first input winding 242, and a second input diode 238 is coupled node 222 and second input winding 252 as shown. In one example, first and second input diodes 234 and 238 are fast diodes and are coupled to external terminals of each input winding 242 and 252 in the direction of current flow that transfers energy from the input windings to the output windings, which prevents any reverse direction circulating current that may otherwise happen due to the common issue of the non equal unbalanced turns in input windings that could create extra loss lowering efficiency.

As shown in the example depicted in FIG. 2, an additional feedback/supply winding 290 is wound around second magnetic core 255. In one example, feedback/supply winding 290 is wound around only one of the plurality of magnetic cores. In the illustrated example, one end of feedback/supply winding 290 is coupled to feedback/supply circuit 291 and the other end of feedback/supply winding 290 is coupled to a reference terminal 288 in the input side of energy transfer element 240.

In one example, a power switch S1 270 is coupled to first and second input windings 242 and 252 at node 224, and to the input 210 of flyback power converter 200. In one example, a switch drive signal 299 is coupled to be received by power switch S1 270 from a controller 298 to control the switching of power switch S1 270. In one example, controller 298 receives a feedback signal 295 from feedback/supply circuit 291 from feedback/supply winding 290 to generate switch drive signal 299. Feedback signal 295 is a signal representative of an output value at an output 285 of the flyback power converter 200. In the illustrated example, feedback/supply winding 290 generates feedback signal 295 by sensing the flux in the magnetic core 255 to provide feedback signal 295 to the controller 298 to generate switch drive signal 299 to control the transfer of energy from the input 210 to the output 285 of flyback power converter 200. In the illustrated example, feedback/supply supply circuit 291 also provides the supply voltage 296 for the controller 298 across a bypass capacitor 297.

In one example, controller 298 and power switch S1 270 are both included in an integrated circuit. In one example, the integrated circuit including both controller 298 and power switch S1 270 is a monolithic integrated circuit. In another example, the integrated circuit including both controller 298 and power switch S1 270 is a hybrid integrated circuit. In yet another example, controller 298 and power switch S1 270 are not included in the same integrated circuit.

In an example with universal input flyback, the controller 298 may also receive an input level signal 294 through the input voltage level detection circuitry 293 coupled to a dc bus at node 292 across input capacitor 220 after the rectifier 211. In the illustrated example, capacitor 220 provides a low impedance path for bypassing the switching current ripples. In one example, a clamp circuit 230 across the first and second input windings 242 and 252 protects the power switch S1 270 from the high amplitude oscillations due to the leakage that may occur when power switch S1 270 is switched off. In the illustrated example, clamp circuit 230 includes a resistor-capacitor-diode plus zener circuit as shown.

As shown in the depicted example, divided energy transfer element 240 also includes a plurality of output windings, including a first output winding 243 wound around first magnetic core 245 and a second output winding 253 wound around second magnetic core 255. As shown in the example, a rectified output of first output winding 243 is coupled in series with a rectified output of second output winding 253. In one example, first output winding 243 includes a plurality of sections having rectified outputs coupled in series, including first section 244 and second section 246 as shown. Similarly, second output winding 253 includes a plurality of sections having rectified outputs coupled in series, including first section 254 and second section 256 as shown.

As shown in FIG. 2, output windings 243 and 253 are wound around magnetic cores 245 and 255 and feedback/supply winding 290 around core 255 to have a polarity that is opposite to the polarity of input windings 242 and 252. As can be appreciated, the opposite polarities of the input windings 242 and 252 and feedback/supply winding 290 and the output windings 243 and 253 are illustrated in FIG. 2 with the dot polarities shown on opposites ends of the respective windings as indicated.

In the example shown in FIG. 2, rectifying output diodes and filter capacitors are coupled to each of the plurality of sections of the plurality of output windings of energy transfer element 240. To illustrate, output diode 262 is coupled to first section 244 of output winding 243, output diode 264 is coupled to second section 246 of output winding 243, output diode 266 is coupled to first section 254 of output winding 253, and output diode 268 is coupled to second section 256 of output winding 253 as shown. Similarly, filter capacitor 272 is coupled across first section 244 of output winding 243, filter capacitor 274 is coupled across second section 246 of output winding 243, filter capacitor 276 is coupled across first section 254 of output winding 253, and filter capacitor 278 is coupled across second section 256 of output winding 253 as shown.

Continuing with the illustrated example, an inductor 280 is coupled between the output windings 243 and 253 of energy transfer element 240 and the output 285 of flyback power converter 200. In addition, capacitors 282 and 283 are stacked and coupled across output windings 243 and 253 at the output 285 as shown. As shown in the illustrated example, the node between stacked capacitors 282 and 283 at the output 285 is labeled as node 286. As shown, a load 289 is to be coupled to the output 285 of flyback power converter 200. In one example, load 289 is a long single string of LEDs to be powered by flyback power converter 200 in accordance with the teachings of the present invention. It is noted that load 289 is also coupled as shown to the reference terminal 287 at the output 285 of flyback power converter 200. In the example, reference terminal 287 on the output side of energy transfer element 240 is galvanically isolated from the reference terminal 288 on the input side of energy transfer element 240. Accordingly, energy transfer element 240 provides isolation between the input and output sides of the energy transfer element 240 in accordance with the teachings of the present invention.

In operation, the output current from each output winding section 244, 246, 254 and 256 is individually rectified by output diodes 262, 264, 266 and 268, respectively. In the example, the bulk electrolytic filter capacitors 272, 274, 276 and 278 are coupled across external terminals of each rectified output winding help to filter the output. As shown in the depicted example, the negative terminal of the rectified and filtered dc voltage of each output winding section 244, 246, 254 and 256 is coupled to the corresponding positive terminal of the next output winding section 244, 246, 254 and 256. In this way, the dc outputs of all output winding sections either on the same magnetic core or on other magnetic cores, are coupled in series, thus combining the output voltages to a total dc output voltage that is at a much higher level and yet with a reasonable number of isolation layers. Energy transfer element 240 therefore has a lower profile with a reduced size and height compared to an energy transfer element with just a single core with single input and output windings.

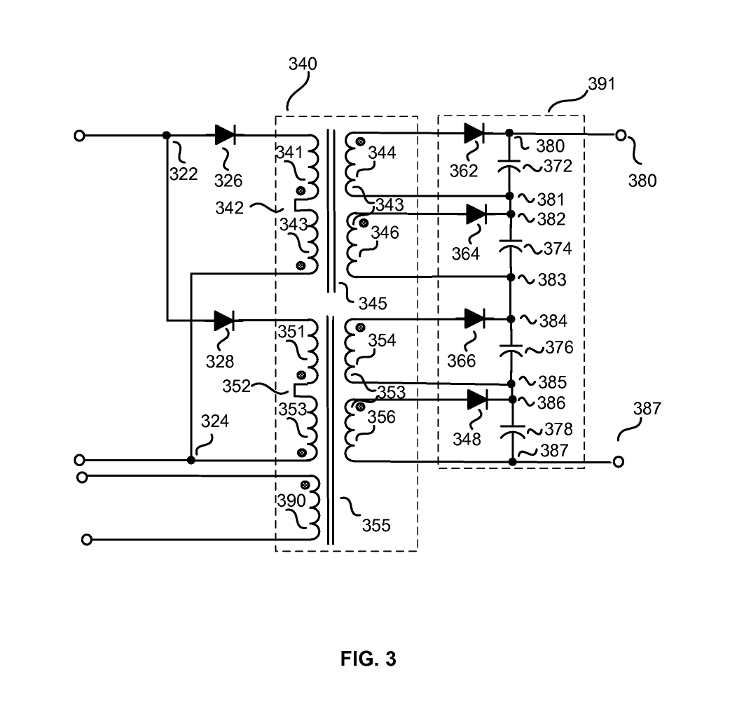

FIG. 3 shows generally a schematic of yet another example of an energy transfer element 340 for use in a flyback power converter in accordance with the teachings of the present invention. It is noted that energy transfer element 340 also has a divided structure, similar to energy transfer element 140 of FIG. 1 and energy transfer element 240 of FIG. 2. In one example, energy transfer element 340 of FIG. 3 can be used in place of energy transfer element 240 of FIG. 2 in accordance with the teachings of the present invention. As shown in FIG. 3, energy transfer element 340 has a plurality of magnetic cores, including first magnetic core 345 and second magnetic core 355. In one example, divided energy transfer element 340 includes a plurality of input windings, including a first input winding 342 wound around first magnetic core 345 and a second input winding 352 wound around second magnetic core 355. As shown in the example, first input winding 342 is coupled in parallel with second input winding 352. In one example, first input winding 342 includes a plurality of sections having rectified outputs coupled in series and wound around magnetic core 345, including first section 341 and second section 343 as shown. Similarly, second input winding 352 includes a plurality of sections having rectified outputs coupled in series and wound around magnetic core 355, including first section 351 and second section 353 as shown.

As shown in the depicted example, divided energy transfer element 340 also includes a plurality of output windings, including a first output winding 343 wound around first magnetic core 345 and a second output winding 353 wound around second magnetic core 355. As shown in the example, a rectified output of first output winding 343 is coupled in series with a rectified output of second output winding 353. In one example, first output winding 343 includes a plurality of sections having rectified outputs coupled in series and wound around magnetic core 345, including first section 344 and second section 346 as shown. Similarly, second output winding 353 includes a plurality of sections having rectified outputs coupled in series and wound around magnetic core 355, including first section 354 and second section 356 as shown.

As shown in the example depicted in FIG. 3, a feedback/supply winding 390 is also wound around second magnetic core 355. In one example, feedback/supply winding 390 is wound around only one of the plurality of magnetic cores. In one example, feedback/supply winding 390 on magnetic core 355 is a winding that utilizes the flux change on magnetic core 355 to provide a feedback signal representative of an output of the power converter in response to the load current demand and could also provide a dc supply for the controller. In one example, the feedback/supply winding 390 of FIG. 3 could be coupled to feedback/supply circuit 291 of FIG. 2.

Referring back to FIG. 3, feedback/supply winding 390 as well as output windings 343 and 353 are wound around magnetic cores 345 and 355 to have a polarity that is opposite to the polarity of input windings 342 and 352. As can be appreciated, the opposite polarities of the input windings 242 and 252 and feedback/supply winding 390 and the output windings 343 and 353 are illustrated in FIG. 3 with the dot polarities shown on opposites ends of the respective windings as indicated.

In operation with a flyback power converter, the divided core and winding structure of energy transfer element 340 distributes the transfer of energy from the plurality of input windings 342 and 352 to the plurality of output windings 343 and 353 among the plurality of magnetic cores 345 and 355. By sharing the distribution of the transfer of energy among the plurality of cores and windings and lower the power rating requirements as discussed, it is appreciated that each of the cores can have lower profile and have a smaller size and smaller height than known energy transfer elements that have the same power rating and utilize a single magnetic core with single input and output windings.

In one example, the first and second sections 341 and 343 of input winding 342 are coupled in series on a bobbin on magnetic core 345, and the first and second sections 351 and 352 of input winding 352 are coupled in series on a bobbin on magnetic core 355. In one example, the ends of input windings 342 and 352 are coupled in parallel at nodes 322 and 324 through printed circuit board traces. In the example, there is an equal distribution current through the input windings 342 and 352 with the parallel coupling of the input windings on the different magnetic cores. By distributing the current among the plurality of input windings as discussed, it is appreciated that relative size of conductors or wires utilized for each magnetic core 342 and 352 is smaller and less bulky than the sizes of the conductors or wires utilized in known energy transfer elements that have the same power rating and utilize a single magnetic core.

In order to reduce the risk of circulating current between the parallel input windings 342 and 352 due to unbalanced input windings, diode 326 is coupled between node 322 and input winding 342 and diode 328 is coupled between node 322 and input 352 as shown. In one example, diodes 326 and 328 are fast diodes and are coupled in a direction such that they conduct current to transfer energy from the input side of energy transfer element 340 to the output side of energy transfer element 340, but prevent any current reverse direction, which could occur due to possibility of an unbalanced winding structure resulting in extra losses and lower efficiency.

In one example, the ends of each section 344, 346, 354 and 356 of output windings 343 and 353 are brought out on the bobbins of the respective magnetic cores 345 and 355 such that the rectified outputs of each section are coupled together in series as shown through bobbin pins coupled to respective printed circuit board traces. In the output section 391 illustrated in FIG. 3, high frequency ac current from each section of the output windings during the off time of the power switch is rectified by the corresponding output diode and ripple is filtered through the corresponding output bulk electrolytic capacitor to generate a dc output voltage from each section of the output windings.

As shown in the example of FIG. 3, output winding section 344 on magnetic core 345 is rectified and filtered through diode 362 and capacitor 372. The output winding section 346 on magnetic core 345 is rectified and filtered through diode 364 and capacitor 374. The output winding section 354 on magnetic core 355 is rectified and filtered through diode 366 and capacitor 376. The output winding section 356 on magnetic core 355 is rectified and filtered through diode 348 and capacitor 378.

As shown in the depicted example, the dc outputs across bulk capacitors 372, 374, 376 and 378 of the section windings 344, 346, 354, and 356, respectively, are externally stacked through the printed circuit board traces. In other words, the negative terminal of each output bulk capacitor is connected to the corresponding positive terminal of the next bulk capacitor. For instance, as shown in FIG. 3, node 381 is coupled to node 382, node 383 is coupled to node 384, and node 385 is coupled to node 386. As a result, the dc outputs of all output windings, either on the same magnetic core or on the different magnetic core of the divided structure of the energy transfer element 340 are coupled in series. Accordingly, the total output voltage is distributed across the nodes 380 through 387. It is appreciated that a high output voltage is realized, which in example of FIG. 3 is four times the voltage across each individual output winding section. It is further appreciated that this high output voltage is realized with an energy transfer element 340 having an overall reduced size and height with reasonable layer isolation, which would otherwise not be achievable with a single core and single input and output windings.

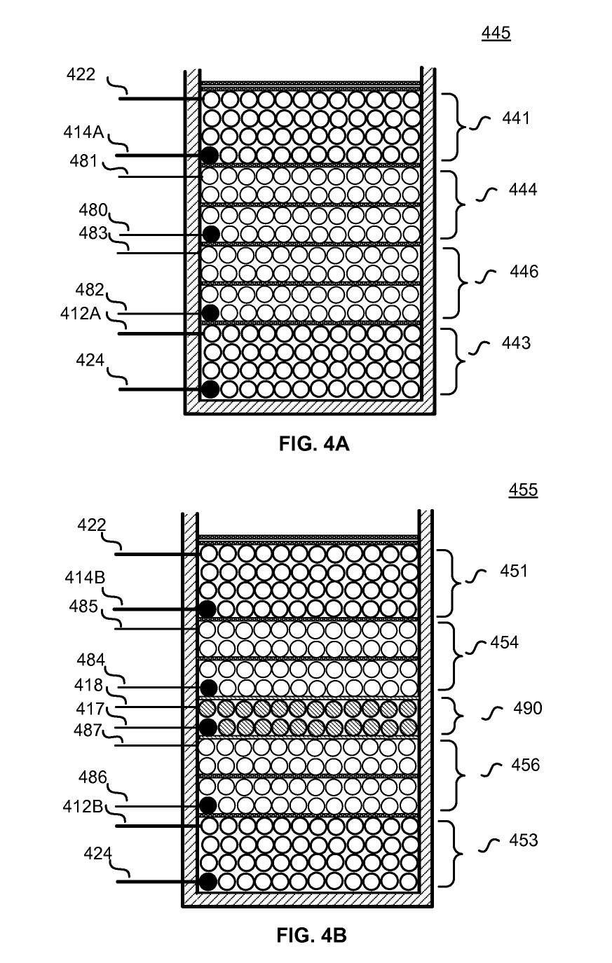

FIGS. 4A and 4B are cross-section illustrations that show example physical structures of layers of input and output windings on the bobbins that are mounted on the magnetic cores of the divided energy transfer element 340 of FIG. 3. It is noted that for the sake of simplicity, only one side of each bobbin window is illustrated in FIGS. 4A and 4B. As shown in FIG. 4A, layers of input and output winding sections are distributed in multiple sections on the bobbin. As can be appreciated, each winding has a limited number of layers and the input and output winding section layers are placed alternative to each other with the required isolation.

To illustrate, FIG. 4A shows a winding structure 445 with first and second sections 441 and 443 of an input winding wound around a bobbin, which is mounted on a first magnetic core. In addition, first and second sections 444 and 446 of an output winding are also wound around the bobbin between the layers of the first and second sections 441 and 443 of the input winding. Thus, the first and second sections 441 and 443 are wound around the bobbin as the first and last windings on the bobbin, including the required isolation between layers and other windings based on the voltage rating of each section of winding. For instance, as shown in the illustrated example, isolation tape is applied for every two layers of output winding sections 444 and 446 based on the voltage rating.

In the example, the two sections 441 and 443 of the input winding are coupled in series by coupling their terminals of different polarity, which are illustrated in FIG. 4A as terminals 412A and 414A, on a common pin of bobbin (not shown). In the example, winding terminals 482 and 483 for output winding section 446 as well as winding terminals 480 and 481 for output winding section 444, are brought out and are coupled to bobbin pins. Similar to the example flyback power converters illustrated in FIGS. 1-3, the dc output of each output winding section 444 and 446 is then rectified and filtered with an output diode rectifier coupled to an individual output bulk capacitor rated for a fraction of the total high voltage dc to be applied to load.

Referring now to FIG. 4B, a winding structure 455 is shown with first and second sections 451 and 453 of an input winding wound around a bobbin, which is mounted on a second magnetic core. First and second sections 454 and 456 of an output winding are also wound around the bobbin between the layers of the first and second sections 451 and 453 of the input winding. In addition, FIG. 4B shows that the example winding structure 455 also includes a feedback/supply winding 490 wound around the bobbin between the layers of the first and second sections 454 and 456 of the output winding.

Similar to the winding structure 445 illustrated in FIG. 4A, the first and second sections 451 and 453 of the input winding are wound as the first and last windings on the bobbin with the required isolation between layers and other windings based on the voltage rating of each section of winding. For instance, as shown in the illustrated example, isolation tape is applied for every two layers of output winding sections 454 and 456 based on the voltage rating.

In the example, the two sections 451 and 453 of the input winding are coupled in series by coupling their terminals of different polarity, which are illustrated in FIG. 4B as terminals 412B and 414B, on a common pin of bobbin (not shown). In one example, winding terminals 417 and 418 for feedback/supply winding 490 are brought out and coupled to bobbin pins (not shown), which are coupled to feedback/supply circuitry through a printed circuit board, similar to for example the feedback/supply circuit 291 shown in FIG. 2. Referring back to the example shown in FIG. 4B, winding terminals 486 and 487 for output winding section 456 as well as winding terminals 484 and 485 for output winding section 454 are brought out and coupled to bobbin pins. As illustrated for instance in the example flyback power converters shown in FIGS. 1-3, the dc output of each output winding section 454 and 456 is then rectified and filtered with an output diode rectifier coupled to an individual output bulk capacitor rated for a fraction of the total high voltage dc to be applied to load.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific voltages, currents, frequencies, power range values, times, etc., are provided for explanation purposes and that other values may also be employed in other embodiments and examples in accordance with the teachings of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

What is claimed is:

1. An energy transfer element, comprising:
first and second magnetic cores;
first and second input windings wound around the first and second magnetic cores, respectively, wherein the first input winding is coupled in parallel with the second input winding;
first and second output windings wound around the first and second magnetic cores, respectively, wherein a rectified output of the first output winding is coupled in series with a rectified output of the second output winding, wherein the first and second input windings have a first polarity and the first and second output windings have a second polarity, wherein the first polarity is an opposite of the second polarity.

2. The energy transfer element of claim 1 wherein the first output winding comprises first and second sections, wherein the second output winding comprises first and second sections, wherein a rectified output of the first section of the first output winding is coupled in series with a rectified output of the second section of the first output winding, wherein a rectified output of the first section of the second output winding is coupled in series with a rectified output of the second section of the second output winding, wherein the rectified outputs of the first and second sections of the first and second windings are coupled in series.

3. The energy transfer element of claim 2 wherein each of the first and second sections of the first and second output windings have the second polarity that is the opposite of the first polarity of the first and second input windings.

4. The energy transfer element of claim 2 further comprising:
a first output diode coupled to the first section of the first output winding to rectify the output of the first section of the first winding;
a second output diode coupled to the second section of the first output winding to rectify the output of the second section of the first winding;
a third output diode coupled to the first section of the second output winding to rectify the output of the first section of the second winding; and
a fourth output diode coupled to the second section of the second output winding to rectify the output of the second section of the second winding.

5. The energy transfer element of claim 4 wherein first, second, third and fourth filter capacitors are coupled in series and stacked across the first and second output windings, wherein the first filter capacitor is coupled across the rectified output of the first section of the first output winding, wherein the second filter capacitor is coupled across the rectified output of the second section of the first output winding, wherein the third filter capacitor is coupled across the rectified output of the first section of the second output winding, and wherein the fourth filter capacitor is coupled across the rectified output of the second section of the second output winding.

6. The energy transfer element of claim 1 wherein each of the first and second input windings comprises a first section coupled in series with a second section, wherein the first and second sections of the first input windings are coupled in parallel with the first and second sections of the second input winding.

7. The energy transfer element of claim 6 wherein each of the first and second sections of the first and second input windings have the first polarity that is the opposite of the second polarity of the first and second output windings.

8. The energy transfer element of claim 6 wherein the first section of the first input winding wound around the first magnetic core is separated from the second section of the first input winding wound around the first magnetic core with the first output winding wound around the first magnetic core between the first and second sections of the first input winding.

9. The energy transfer element of claim 6 wherein the first section of the second input winding wound around the second magnetic core is separated from the second section of the second input winding wound around the second magnetic core with the second output winding wound around the second magnetic core between the first and second sections of the second input winding.

10. The energy transfer element of claim 1 wherein first and second input diodes are coupled to the first and second input windings, respectively, in a direction that allows a transfer of energy from the first and second input windings to the first and second output windings.

11. The energy transfer element of claim 1 further comprising a feedback/supply winding wound around only one of the first and second magnetic cores, wherein the feedback/supply winding has the second polarity that is the opposite of the first polarity of the first and second input windings.

12. The energy transfer element of claim 11 wherein the feedback/supply winding and the first and second input windings are coupled to a first reference terminal, wherein the first and second output windings are coupled to a second reference terminal, wherein the first reference terminal is galvanically isolated from the second reference terminal.

13. A flyback power converter, comprising:
an energy transfer element including a plurality of magnetic cores, the energy transfer element further including a plurality of input windings, wherein each one of the plurality of input windings is wound around a corresponding one of the plurality of magnetic cores and is coupled in parallel across an input of a flyback power converter, the energy transfer element further including a plurality of output windings, wherein each one of the plurality of output windings is wound around a corresponding one of the plurality of magnetic cores and includes rectified outputs coupled in series across a dc output of a flyback power converter;
a power switch coupled to the plurality of input windings and coupled to the input of the power supply; and
a controller coupled to the power switch and coupled to receive a feedback signal representative of the output of the flyback power converter, wherein the controller is coupled to control a switching of the power switch to control a transfer of energy from the input of the flyback power converter through the energy transfer element to the output of the flyback power converter.

14. The flyback power converter of claim 13 wherein the controller is coupled to control the switching of the power switch to control the transfer of energy from the input of the flyback power converter to a single string of light emitting diodes (LEDs) to be coupled to the output of the flyback power converter.

15. The flyback power converter of claim 13 wherein the energy to be transferred to the output of the flyback power converter is coupled to be distributed across the rectified outputs of each of the plurality of output windings coupled in series across the dc output of the flyback power converter.

16. The flyback power converter of claim 13 wherein the energy to be transferred to the output of the flyback power converter is coupled to be distributed across each of the plurality magnetic cores.

17. The flyback power converter of claim 13 wherein each one of the plurality of input windings comprises a plurality of sections coupled in series.

18. The flyback power converter of claim 17 wherein ends of each of the plurality of sections of each of the plurality of input windings are coupled to respective bobbin pins coupled to respective printed circuit board traces.

19. The flyback power converter of claim 13 wherein each of the plurality of output windings comprises a plurality of sections having rectified outputs coupled in series.

20. The flyback power converter of claim 19 further comprising a plurality of rectifiers, wherein each one of the plurality of rectifiers is coupled to a corresponding one of the plurality of sections of the plurality of output windings.

21. The flyback power converter of claim 19 further comprising a plurality of filter capacitors, wherein each one of the plurality of filter capacitors is coupled across a corresponding one of the plurality of sections of the plurality of output windings.

22. The flyback power converter of claim 19 wherein ends of each of the plurality of sections of each of the plurality of output windings are coupled to respective bobbin pins coupled to respective printed circuit board (PCB) traces.

23. The flyback power converter of claim 22 wherein the plurality of filter capacitors are coupled in series and stacked across the output of the flyback power converter.

24. The flyback power converter of claim 13 further comprising a plurality of input diodes, wherein each one of the plurality of input diodes is coupled to a corresponding one of the plurality of input windings in a direction that allows a transfer of energy from the plurality of input windings to the plurality of output windings.

25. The flyback power converter of claim 13 further comprising a control winding wound around one of the plurality of magnetic cores, wherein the feedback/supply winding is coupled to generate the feedback signal representative of the output of the flyback power converter.

26. The flyback power converter of claim 25 wherein the feedback/supply winding is further coupled to the control circuit to provide a dc supply to the control circuit.

27. The flyback, power converter of claim 13 wherein the power switch and control circuit in comprised in an integrated circuit.
